(19) United States
(12) Patent Application Publication
(10) Pub. No.: US 2013/0051761 A1
(43) Pub. Date: Feb. 28, 2013

(54) SELECTIVE DISPLAY OF A TAGGED LIST OF BROADCAST PROGRAMS AVAILABLE THROUGH A VIDEO RECORDER OR SET TOP BOX STB

(71) Applicant: James Edwin Hailey, Indianapolis, IN (US)

(72) Inventor: James Edwin Hailey, Indianapolis, IN (US)

(73) Assignee: THOMSON LICENSING, Issy de Moulineaux (FR)

(21) Appl. No.: 13/639,978

(22) PCT Filed: May 17, 2010
(86) PCT No.: PCT/US10/01449

§ 371 Date: Oct. 8, 2012

(51) Int. Cl. H04N 9/80

(52) U.S. Cl. 386/241; 386/E09.011

(57) ABSTRACT

The disclosed methods and systems provide for selectively including programs in listings of programs available though a digital video recorder (DVR). The method involves receiving a selection of a program available through the DVR. The received selected program is then tagged. The tagged program can then be selectively included in a listing of programs available through the DVR. This can involve omitting selected programs or only including selected programs from the display of the list of available programs.

### BACKGROUND OF THE INVENTION

1. Technical Field

This invention relates to the field of digital video recorders (DVRs). More particularly, this invention relates to selectively including programs in a listing of programs available through a digital video recorder (DVR).

2. Description of Related Art

Digital Video Recorder (DVRs) and Home Media DVRs are common devices in the home. Network DVRs are also popular with some service providers since they reduce the cost of customer premises equipment. However, this technology comes with new parental control issues since program titles listed in menus can be viewed by others in the household either at the DVR or other display devices-in the home.

With a DVR, programs can be recorded and played back at the convenience of the consumer. Once a program is recorded, the consumer can easily find the desired program by viewing a user interface menu having a listing of programs available through the DVR. Additional information such as description, rating, actors, and length can also be provided. Much of the popularity of the DVR is due to the listing of available programs which help the consumer choose desired programming. With a Home Media DVR or Network DVR, the consumer can view the listing of available programs from a number of display devices in the home. This is very convenient; however, it also creates parental control problems since anyone in the household can view the listing of available programs which can include programs that are inappropriate for certain members of the household.

In some systems, a rating limit is used to prevent DVR content from being viewed; however, ratings limits can be difficult to use and would not prevent access to programs that have appropriate ratings (such as PG) but is still contain potentially objectionable subject matter. Furthermore, most of these systems only block access, so programs (which can have inappropriate or objectionable titles) still appear in the listing of programs available though the DVR. Since some programs can have inappropriate or objectionable titles as well as content, it can be advantageous to be able to control which programs are included in listings of programs available through the DVR.

### SUMMARY OF THE INVENTION

In accordance with one embodiment, a method is provided for selectively including programs in listings of programs available though a digital video recorder (DVR). The method involves receiving a selection of a program available through the DVR. The received selected program is then tagged. The tagged program can then be selectively included in a listing of programs available through the DVR.

With this methodology selected and tagged programs can be omitted from the listing of programs available through the DVR. Conversely, selected and tagged programs can be exclusively displayed in the listing of programs available through the DVR.

In accordance with another embodiment, a DVR system is provided for selectively including programs in a listing of programs available through the DVR system. The system involves a receiver, a processor, storage and an output interface. The receiver is configured to receive a program content to be available through the DVR. The processor is configured to select songs from the digital broadcast stream based on a music preference for a user and assemble the selected songs into a custom channel. The storage is used to store the selected songs from the digital broadcast stream. The output interface is configured to output an assembled custom channel featuring the selected songs.

### BRIEF DESCRIPTION OF THE DRAWINGS

FIG. 1A is a diagram depicting an embodiment of a DVR system typically operated and viewed from one location.

FIG. 1B is a diagram depicting an embodiment of a DVR system that can be operated from operated from more than one location and can distribute content to more than one location.

FIG. 1C is a diagram depicting an embodiment of a DVR system in which the content is stored and accessed remotely.

FIG. 2 is a block diagram depicting the elements of a system in accordance with one embodiment.

FIG. 3 is a flow diagram illustrating a methodology in accordance with one embodiment.

FIG. 4A is a flow diagram illustrating additional steps of a methodology in accordance with an embodiment.

FIG. 4B is diagram depicting an on-screen menu relating to the flow diagram of FIG. 4A.

FIG. 5A is a flow diagram illustrating additional steps, of a methodology in accordance with another embodiment.

FIG. 5B is diagram depicting an on-screen menu relating to the flow diagram of FIG. 5A.

### DETAILED DESCRIPTION

The methodologies, systems and teachings disclosed herein can be embodied in or as a digital video recorder (DVR) that is capable of selectively listing programming available thru the DVR. The selective listing can involve omitting selected programs from the listing of available programs or only including selected programs in the listing of available programs. The selective listing of programs does not mean that an omitted program is blocked or otherwise not available though the DVR, but merely the title of the program is not included in the listing of available programs presented to a user.

In the examples described herein, the term “digital video recorder” or “DVR” is used for the device that provides the functionality of the invention. The term DVR is meant to include all such devices or software that are capable of recording, storing, and displaying or otherwise outputting programs. This includes Personal Video Recorders (PVRs), media servers, personal computers (PCs), or the like.

The term “program” is used herein to refer to television shows, movies, music, sports or music events, podcasts, or any other content provided by content providers that can be recorded, stored, streamed, and displayed or otherwise outputted by a DVR.

The term “listing of programming available through the DVR” is used herein to refer to the on-screen listing of programs that have been recorded and are available for playback, on-screen listing of programs available for download or streaming through the DVR, on-screen program guides listing upcoming programs, or any other on-screen menu that can display titles of programs that can be recorded, stored, streamed, or viewed using the DVR.

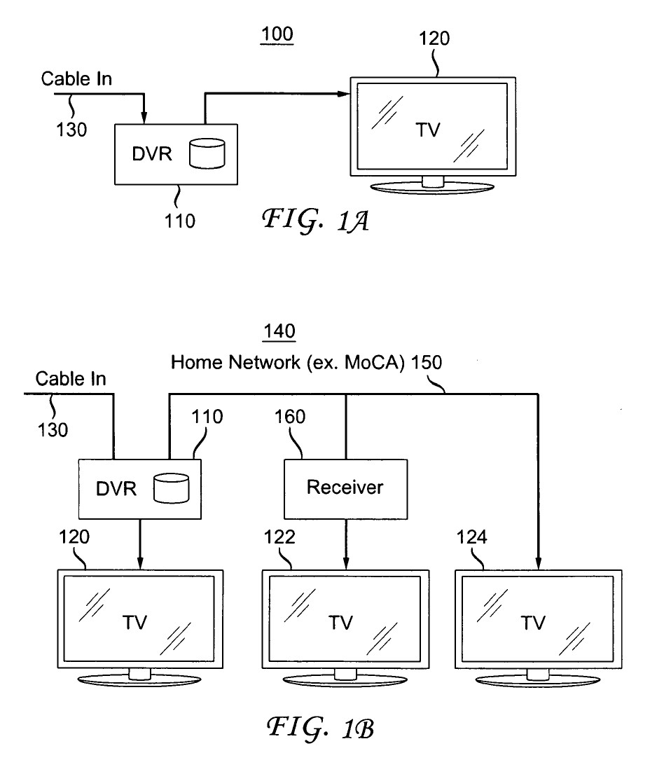

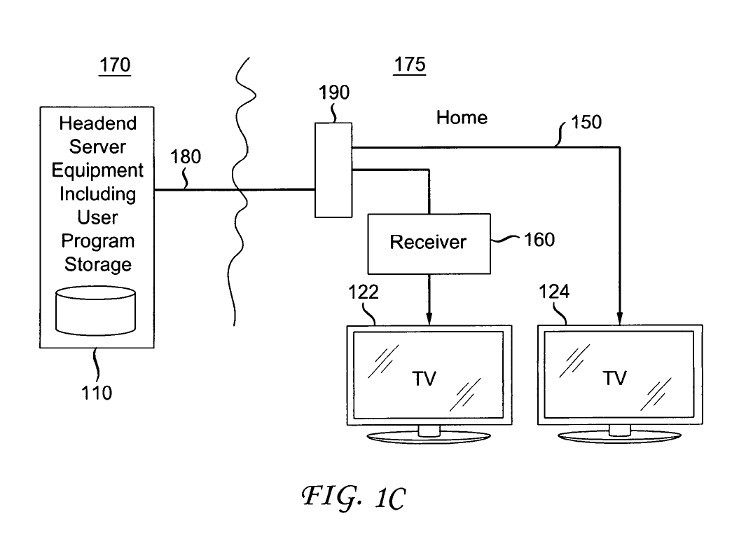

FIG. 1A depicts one environment 100 in which a DVR with the functionality described herein can be employed. At its heart is a DVR 110. In this embodiment, the DVR 110 is connected to a user's display device and/or audio system 120 such as a television. The connection between the DVR and the television can be a coaxial, RCA, HDMI or other type of audio visual (AV) connection.

The DVR 110 is configured to receive programs from one or more sources. For example the DVR 110 can be configured to receive programs over cable 130 from a cable provider. In another embodiment, the DVR 110 could be part of a satellite system that receives programs from a satellite. In another embodiment, the DVR 110 can be configured to receive programs over the air from an antenna. In another embodiment, the DVR 110 can receive programs over a network. In yet another embodiment, the DVR 110 can be configured to receive programs from any combination of sources. It should be understood that these sources of broadcast streams are merely illustrative; other possible sources for broadcast streams will be apparent to one skilled in the art given the benefit of this disclosure.

In the embodiment of FIG. 1A the DVR 110 is a set top box designed to be connected to a user's display device and audio system 120 such as a television and stereo system for outputting content received from a content provider. However, in other embodiments, the consumer electronics device 110 can be a stand-alone device that includes its own video and audio reproduction capabilities, which does not need to be connected to a user's display device and/or audio system 120. In still other embodiments the DVR 110 can be centrally located and distribute content to one or more remotely located display devices 120.

FIG. 1B depicts another environment 140 in which a DVR with the functionality described herein can be employed. In this example the DVR 110 is part of a home network 150. For example, the DVR 110 could be implemented as or part a gateway device that acts as a central distribution hub for television and/or internet services. As with FIG. 1A, the DVR 110 is configured to receive programs from one or more sources, such as cable 130. However, in this example, the DVR 110 is connected to multiple display devices and/or audio systems 120, 122, 124.

In the example of FIG. 1B, the DVR 110 is connected to the first display device and/or audio system 120 in a conventional manner such as described in FIG. 1A. The DVR 110 is connected to the second 122 and third 124 display devices and/or audio systems over a home network 150. In the depicted system the second display device 122 is interfaced with the home network 150 using a set top box 160 while the third display device 124 is connected directly to the home network 150. In the case of the second display device 122, the set top box 160 is connected to second display device 122 in a conventional manner using a coaxial, RCA, HDMI, or other AV connection and connected to the DVR 110 using a network connection. In the case of the third display device 124, a conventional coaxial, RCA, HDMI, or other AV connection is not used as the third display device 124 has a network connection. Examples of suitable networks include Ethernet or multimedia over coaxial (MoCa) networks. Other types of suitable home networks will be apparent to one skilled in the art given the benefit of this disclosure. In this configuration, for the remotely located display device 122 and 124, the commands to control the DVR 110 are received by the set top box 140 or display device 124 and are conveyed to the DVR 110 over the home network 150.

FIG. 1C depicts another embodiment of a network DVR 110 wherein the DVR 110 is located outside the user's home 175. In this example the DVR 110 is part of head-end server equipment 170 located in the service provider's facilities. The DVR 110 is connected over a broadband connection 180 to the user's home 175 through a hub or gateway device 190 that is configured to interface with the DVR 110 remotely.

The gateway device 190 is in turn connected to set top box 160 or display device 124 over a home network 150 such as Ethernet or MoCa network similar to FIG. 1B. In this configuration the commands to control the DVR 110 are received by the set top box 140 or display device 124 and are conveyed to the gateway device 190 over the home network 150. The gateway device in turn conveys the commands to the DVR 110 over the broadband connection 180.

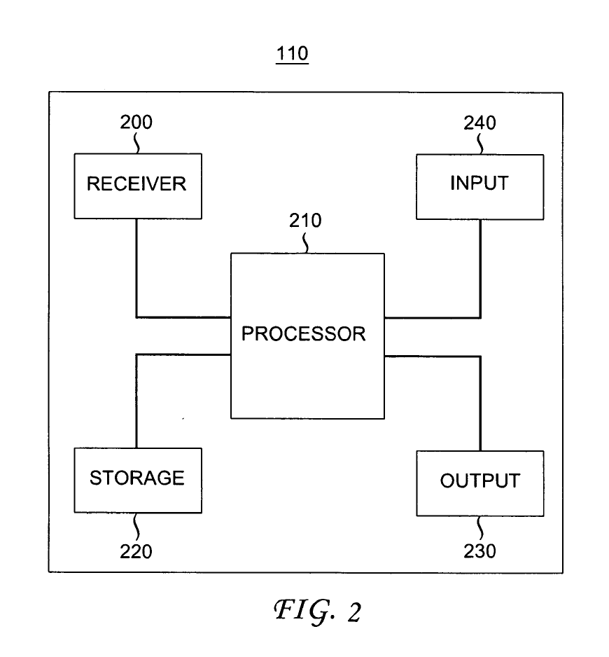

FIG. 2 is a block diagram depicting the elements of DVR 110 in accordance with one embodiment. In this embodiment, the DVR 110 comprises a receiver 200, a processor 210, storage 220, and an output interface 230. In some embodiments, the consumer electronics device can further include an input interface 240. Each of these elements will be discussed in more detail below.

The receiver 200 is configured to receive content such as programs. The programs can be provided on channels or streams that are part of broadcast or internet content from content providers. The type and configuration of the receiver depends on the source and format of the content. As such, the receiver can be configured to receive satellite digital broadcasts, over-the-air digital broadcasts, cable digital broadcasts, internet streams or any combination thereof. The receiver allows the consumer electronic device 110 to access and decode the various channels and programs that are provided as part of the received content. As such, the receiver can contain one or more tuners to tune in or otherwise decode the various channels or streams that are provided as part of the received content. In the case of multiple tuners, the tuners can be for tuning in multiple different channels or streams from a single source, or different channels or streams from different channels or streams.

The processor 210 controls the operation of the DVR 110. The processor runs the software that operates the DVR 110 as well as provides the functionality of the selective listing of this disclosure. This includes receiving a selection of a program, tagging the received selected program, and selectively including the tagged program in a listing of programs available through the DVR. The processor 210 is connected to the receiver 200, storage 220, output interface 230, and, in some embodiments, input interface 240, and handles the transfer and processing of information between these elements. The processor 210 can be general processor or a processor dedicated for a specific functionality. In certain embodiments there can be multiple processors.

The storage 220 is where the software and other information used by the consumer electronics device are stored. The storage 220 can include volatile memory (RAM), non-volatile memory (EEPROM), magnetic media (hard drive), optical media (CD/DVD-Rom), or flash based storage. In certain embodiments the storage 220 will typically include memory as well as large capacity storage such as a hard-drive. The hard drive is where programs recorded on the DVR 110 are stored.

The output interface 230 is configured to provide the programs available through the DVR in the correct format for outputting on a video display or audio device. This content can include programs recorded and stored on the DVR 110 and streams or other internet programs available through the DVR 110. The proper format can include the codec for the content to be output as well as the connector type used to connect to an external video display device or audio device or in some embodiments, the onboard display or speakers. The output interface 230 can also provide the graphics and menus used to indicate the content, and information about the content, available on the consumer electronic device 110. In certain embodiments, the output interface 230 includes network connectivity for connecting the DVR to remotely located set top boxes, gateways, and display devices over a home network and/or the internet as described in regards to FIGS. 1B and 1C.

In some embodiments the DVR 110 can further include an input interface 240. The user interface 240 allows the user to interact with the DVR 110. The input interface 240 allows selections of programs to be selectively displayed to be received by DVR 110. The user interface 240 also allows for the selection of content available on the consumer electronic device 110 for playback and the entering of authorization for the display of tagged programs. The user interface 240 can also handle the interfacing with the various devices that can be used to input information, such a remotes, keyboards, etc. In certain devices the input interface can include network connectivity for connecting the DVR remotely located set top boxes, gateways, and display devices over a home network and/or the internet as described in regards to FIGS. 1B and 1C.

It should be understood that the elements set forth in FIG. 2 are illustrative. The consumer electronic device 110 can include any number of elements and certain elements can provide part or all of the functionality of other elements. For example, the much of the functionality of the receiver 200, output interface 230, and input interface 240 can be performed by the processor 210 or multiple general or dedicated processors. Likewise, network connectively can be implemented separate from either the output interface 230 or the input interface 240. Other possible implementation will be apparent to on skilled in the art given the benefit of this disclosure.

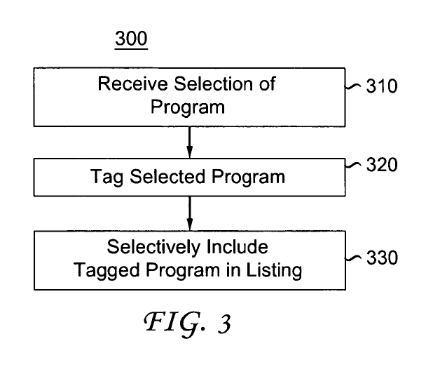

FIG. 3 is a flow diagram depicting a method 300 for selectively displaying titles of available programs in a DVR in accordance with one embodiment. At its most basic, the method involves three steps. The first step is receiving a selection of a program available though the DVR (step 310). The selected program is then tagged (step 320). Finally, the tagged program is selectively included in a listing of program available through the DVR (step 330). Each of these steps will be discussed in more detail below.

In step 310, a selection of a program available through the DVR 110 is received. Programs available through the DVR can include programs that have been recorded, programs that can be streamed or downloaded through the DVR, and even regularly scheduled programs. In certain embodiments, the selection of a program can be provided by a user based on a displayed listing of available programs through the DVR 110 via the user interface. For example the program can be a program that has been previously recorded on the DVR 110 and is displayed in an on-screen listing of recorded program. Alternately, the program can be an upcoming program that is displayed in the program guide. In another embodiment, the program can be a streamed or downloadable program displayed as additional programs available through the DVR 110.

The selection of the program can be received by a user directly, for example thru on-screen menus. Alternately, the selection of program available through the DVR can be based on provided listings or criteria. For example, a listing of programs that are unsuitable for children can be supplied by consumer watch groups that can be downloaded or otherwise inputted to the DVR 110. In another embodiment, selection of programs can be made by the DVR 110 based on the rating, subject matter, or keywords.

Once the selection of a program is received (in step 310) the selected program is then tagged (step 320). The tagging can be automatic upon receiving the selection of a program. Alternatively, the tagging can be selected by the user, for example though a menu of an on-screen display. The tag associated with the program indicates how the program should be handled in listing of programs available thru the DVR 110. In one embodiment the tag indicates that the program is restricted meaning the title of the program is not suitable for general viewing. For example, a mature themed program can be tagged as private indicating that the title of the mature themed program should not be displayed in a general listing of titles available through the DVR 110 where any person might view it.

Conversely the tag can indicate that the program is preferred meaning that the title of the program is a preferred title for display in a listing. For example, a preferred tag can used to tag a program suitable for children, wherein the listing of programming available through the DVR 110 can only list programming tagged as preferred.

In other embodiments, the tag associated with a program can indicate a specific listing of programs that the tagged program should be included in. For example, a program can be tagged to indicate that should be included in a listing of programs for a particular user. Thus, a user “Dave” could have a program tagged to be included in a listing of programs “Dave's Programs.” In other embodiments, such as the example of FIG. 1B or 1C, where multiple display devices 120, 122, and 124 are connected to the DVR 110; a program can be tagged to indicate what display device 120, 122, 124 can display the title of the tagged program. Thus, certain programs could be tagged so as to only appear on a bedroom television, with other programs could be tagged so as to only appear on the family room television. Other possible tagging will be apparent to on skilled in the art given the benefit of this disclosure.

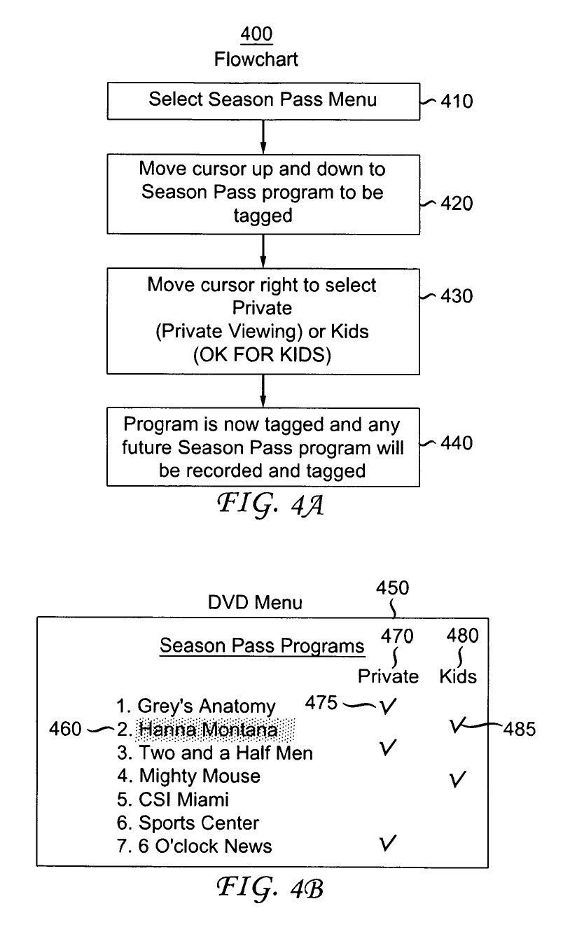

The tagging of programs can be contextual; that is tagging can be implemented depending on how a program is selected. FIGS. 4A and 4B show one embodiment of the inter-workings of the steps of receiving a selection of a program (step 310) and tagging the selected program (step 320). FIG. 4A depicts a flow diagram 400 of the process of how a selected program is tagged using the onscreen season pass menu 450 of FIG. 4B. After the season pass menu 450 is selected (step 410), the cursor 460 is moved up or down in the menu 450 to select a season pass program to be tagged (step 420). In this case, the program “Hanna Montana” has been selected using the cursor 460. The cursor can then be moved right or left to select the type of tagging desired (step 430). In this case the options for tagging are “Private” 470 or “Kids” 480. The “Private” tag indicates the program title is for private viewing only. The “Kids” tag indicates that the title of the program is OK for kids to view. Once a desired option is selected (step 430) the program is tagged. In the example of FIG. 4B, the tagging of programs is indicated by a check mark, thus check mark 475 indicates that the program “Grey's Anatomy” has been tagged as “Private” and check mark 485 indicates that the program “Hanna Montana” has been tagged as “Kids.” In this example, since the menu 450 used to select and tag the programs is the season pass menu, all future recording of the programs listed will be tagged accordingly. Thus all future recordings of “Grey's Anatomy” will be tagged “Private” and all future recording of “Hanna Montana” will be tagged “Kids.”

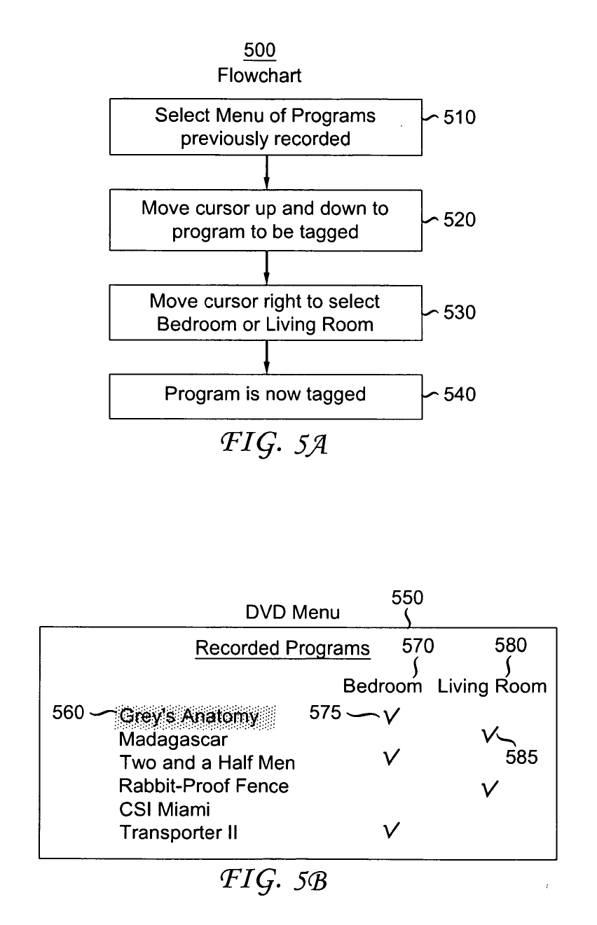

FIGS. 5A and 5B show another embodiment of the inter-workings of the steps of receiving a selection of a program (step 310) and tagging the selected program (step 320). FIG. 5A depicts a flow diagram 500 of the process of how a selected program is tagged using the onscreen recorded programs menu 550 of FIG. 4B. After the recorded program menu 550 is selected (step 510), the cursor 560 is moved up or down in the menu 550 to select a season pass program to be tagged (step 520). In this case, the program “Grey's Anatomy” has been selected using the cursor 560. The cursor can then be moved right or left to select the type of tagging desired (step 530). In this case the options for tagging are “Bedroom” 570 or “Living Room” 580. The “Bedroom” tag indicates the program title is should only be viewable on the display device located in the bedroom. The “Living Room” tag indicates that the titles of the program only be viewable on the display in the living room. Once a desired option is selected (step 530) the program is tagged. In the example of FIG. 5B, the tagging of programs is indicated by a check mark, thus check mark 575 indicates that the program “Grey's Anatomy” has been tagged as “Bedroom” and check mark 585 indicates that the program “Madagascar” has been tagged as “Living Room.” In this example, since the menu 550 used to select and tag the programs is the recorded program menu, just the recorded programs listed will be tagged accordingly. Thus, all only the single episode of “Grey's Anatomy” recorded will be tagged,“Bedroom” and all future recording of “Grey's Anatomy” will be not be automatically tagged.

In some embodiments, the tagging of a program can require authorization. For example, parents may prefer to restrict the ability to tag a program. As such, the tagging of a program by a user as depicted in FIGS. 4A, 4B, 5A, and 5B can require that the user provide a password before the tagging can be performed. This can be implemented similarly to parental lock features currently found televisions and set top boxes. In another embodiment, such as the example of FIG. 1B or 1C, where multiple display devices 120, 122, and 124 are connected to the DVR 110; the DVR can be configured such that the tagging of a program can only be performed through designated devices such as set top box 160 or display device 124.

Referring back to FIG. 3, after the selected program has been tagged (step 320), it can be selectively included in a listing of program available through the DVR 110. An example of a listing of available program though the DVR is the listing of the programs recorded on the DVR and available for playback. Another example of the listing of programs available through the DVR is the listing of “on-demand” movies that can be downloaded or streamed using the DVR. Whether or not a title of a program is displayed in such a listing depends on tag associated with the program.

In some embodiments, a title of a program can be omitted or otherwise excluded from a listing based on the tag associated with the program. An example of this is the case where the program has been tagged “private” such as with the program “Grey's Anatomy” in the embodiment of FIGS. 4A and 4B. Since the program “Grey's Anatomy” has been tagged as “Private” any recording of that program will not be included in a listing of programs available thru the DVR such as the listing of recorded programs in an on-screen display.

In other embodiments, a listing of programs available through the DVR can be comprised entirely of programs that have been tagged accordingly. An example of this is the case of the listing “Dave's Programs” wherein all the titles of programs listed in “Dave's Programs” have been tagged to be included in “Dave's Programs”

In some embodiments, the display of a tagged program in a listing of programs available through the DVR 110 can require authorization. For example, titles of programs tagged as “Private” can only be viewed upon the user providing a password. This can be implemented similarly to parental lock features currently found televisions and set top boxes.

In another embodiment, such as in FIG. 1B or 1C, where multiple display devices 120, 122, and 124 are connected to the DVR 110; the DVR 110 can be configured certain tagged programs can only be viewed on designated devices such as set top box 160 or display device 124. For example, programs tagged “private” can only appear in a listing of programs available displayed on a designated display device which has been authorized to display the titled of tagged programs. Another example of this is the case of FIGS. 5A and 5B wherein programs can have been tagged “Living Room” or “Bedroom.” Thus, the program “Grey's Anatomy” which has been tagged “Bedroom,” as indicated by check 575, will only appear in a listing of available recorded programs displayed on a display device designated as being in the bedroom and the program “Madagascar” which has been tagged “Living Room,” as indicated by check 585, will only appear in a listing of available recorded programs displayed on display device designated as being in the living room.

In still other embodiments, authorization can possess a temporal aspect. That is authorization to include or omit tagged programs depends on the time of day. Thus, in the case of FIGS. 4A and 4B wherein programs have been tagged as “Private” or “Kids” the inclusion or omission of such tagged programs can change based on the time of day. For example, in the hours between 5 A.M. and 8 P.M., when children are the primary user of the DVR, the displayed listing of available programs includes only the titles of programs tagged “Kids”, however, after 8 P.M when the children are in bed, the displayed listing of available programs can include the titles of programs tagged “Private.”

It should be understood that the set-up and management of the selective inclusion of the tagged programs in listings of available programs as well as authorizations, including passwords, designated devices, and temporal aspects can be performed by the user as needed. For example, on-screen menus can be provided to a user to configure or modify any of these aspects.

Accordingly, with this methodology selected and tagged programs can be omitted from the listing of programs available through the DVR. Conversely, selected and tagged programs can be exclusively displayed in the listing of programs available through the DVR.

While the example set forth above has focused on an electronic device, it should be understood that the present invention can also be embedded in a computer program product, which comprises all the features enabling the implementation of the methods described herein, and which, when loaded in a computer system, is able to carry out these methods. Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

Additionally, the description above is intended by way of example only and is not intended to limit the present invention in any way, except as set forth in the following claims.

1. In a digital video recorder (DVR), a method comprising:
receiving a selection of a program available through the DVR;
tagging the received selected program; and
selectively including the tagged program in a listing of programs available through the DVR.

2. The method of claim 1, comprising the step of selecting a program that has been previously recorded on the DVR.

3. The method of claim 1, comprising the step of selecting a program that is scheduled to be recorded by the DVR.

4. The method of claim 1, comprising the step of selecting a program from a listing of programs available through the DVR.

5. The method of claim 1, wherein tagging the received selected program comprises the step of tagging the received selected program as restricted.

6. The method of claim 1, wherein tagging the received selected program comprises the step of tagging the received selected program as preferred.

7. The method of claims 1, wherein selectively including the tagged program in a listing of programs available through the DVR comprises selectively including the tagged program in a listing of programs available through the DVR in response to an authorization.

8. The method claim 7, comprising the step of generating an authorization responsive to a password received from a user.

9. The method of claim 7, comprising the step of generating an authorization responsive to the device displaying the listing of programs available through the DVR.

10. The method of claim 7, comprising the step of generating an authorization responsive to the time of day.

11. The method of claim 1, wherein selectively including the tagged program in a listing of programs available through the DVR comprises:
omitting the tagged program from the listing of programs available through the DVR.

12. The method of claim 1, wherein selectively including the tagged program in a listing of programs available through the DVR comprises:
including only tagged programs in the listing of programs available through the DVR.

13. The method of claim 1, wherein the DVR is a network based DVR.

14. The method of claim 1, wherein the DVR is a gateway device.

15. A DVR system comprising:
a receiver for receiving program content to be available through the DVR
a processor configured to receive a selection of a program, tag the received selected program, and selectively include the tagged program in a listing of programs available through the DVR;
storage for storing the received selected program and tagged program information;
an output interface for providing a listing of programs available through the DVR selectively including the tagged program.

16. The DVR system of claim 15, wherein the output interface further comprises network connectivity for connecting to receivers over a network connection.

17. The DVR system of claim 15, further comprising an input interface for receiving input from a user.

18. The DVR system of claim 17, wherein the input interface is further configured to receive authorization for selectively including a tagged program in a listing of programs available through the DVR.

19. The DVR system of claim 15 wherein processor is configured to omit the tagged program from the listing of programs available through the DVR.

20. The DVR system of claim 15, wherein the processor is configures to include only tagged programs in the listing of programs available through the DVR.
